(19) United States
(12) Patent Application Publication
(10) Pub. No.: US 2009/0018841 A1
(43) Pub. Date: Jan. 15, 2009

(54) Method and apparatus for remote playback of personalized and non-personalized audio messages

(76) Inventors: Marshall T. Leeds, Boca Raton, FL (US); Susan M. Camacho, Davie, FL (US); Steven C. Jacobs, Cooper City, FL (US)

Correspondence Address: BRINKLEY, MORGAN, SOLOMON, TATUM, STANLEY,;LUNNY & CROSBY, LLP, 19TH FLOOR, 200 EAST LAS OLAS BLVD., FORT LAUDERDALE, FL, 33301, US

(21) Appl. No.: 12/217,844

(22) Filed: Jul. 8, 2008

Related U.S. Application Data
(60) Provisional application No. 60/959,256, filed on Jul. 12, 2007.

(51) Int. Cl. G10L 11/00

(52) U.S. Cl. 704/272; 704/E11.001

(57) ABSTRACT

A method and apparatus allow for remotely playing back recorded personalized and non-personalized audio messages to a listener. A first recorded message, which has been personalized for an intended listener, is stored in a first memory of an audio player. A second recorded message, which has not been personalized for an intended listener, is stored in a second memory of the audio player. Responsive to receiving a control command from a remote control device, the audio player plays the messages according to a predetermined arrangement, such as in a predetermined order or at predetermined intervals (e.g., the personalized message may be played a number of times before the non-personalized message is played). In one embodiment, the personalized message contains audio intended to be a calming and/or instructional influence on a small child. In another embodiment, the non-personalized message may include information associated with a sponsoring business.

### CROSS REFERENCE TO RELATED APPLICATIONS

This application claims priority under 35 U.S.C. §119(e)(1) upon U.S. Provisional Application Ser. No. 60/959,256, which is entitled “Method and Apparatus for Remote Playback of Comforting Audio to a Child” and is incorporated herein by this reference.

### BACKGROUND OF THE INVENTION

1. Field of the Invention

The present invention relates generally to voice recordings and playback devices, and more particularly, to a method and apparatus for remotely triggering playback of a parent's pre-recorded voice or other comforting or calming audio to a child or infant.

2. Description of the Prior Art

It is a well-known phenomenon that infants have the ability to identify and respond to their mothers' voices. Studies, such as the one described in Fetus Heart Races When Mom Reads Poetry; New Findings Reveal Fetuses Recognize Mother's Voice In-utero, SCIENCE DAILY, May 13, 2003, http://www.sciencedaily.com/releases/2003/05/030513080440.htm, have even shown that a fetus is able to recognize and distinguish his or her mother's voice from other female voices while still in-utero. A crying or upset infant will often calm down just by hearing his or her mother's voice, particularly when the mother sings a lullaby. An infant automatically associates the sound of a mother's voice with a feeling of warmth and comfort; thus, these feelings are generally imprinted in the child's mind, as well as memories associated with his or her surroundings.

However, there are many instances when the mother is not available to comfort the child. For instance, the infant may be left in the care of a relative or other caretaker, or the mother may simply be momentarily occupied with other matters and is unable to immediately rush to comfort the child. When the infant does not receive immediate attention, he or she may become even more agitated and upset, whereby the difficulty level required to eventually calm the child increases tremendously.

A recording of the mother's voice can temporarily provide comfort to the child; however, typical audio playback devices usually require some manual interaction in order to begin playing recorded audio and provide no visual stimulus for the infant to focus upon. If the infant sees someone trigger the playback without coming to pick him up, he may get further upset—especially if that someone happens to be his mother.

Certain toys and other devices allow playback of pre-recorded messages and sounds. One such device is a baby bottle attachment disclosed in U.S. Pat. No. 6,104,292. The baby bottle attachment is a cylindrically-shaped cup which attaches to the bottom of a baby bottle. The attachment serves as a baby monitor as it detects sounds in the vicinity of the bottle and transmits the sounds to a receiving unit through an FM transmitter. The attachment also has the ability to play pre-recorded messages “meant to be heard by another adult who may not be present at the time.” A “PLAY PROGRAM” button on the attachment must be activated before the pre-recorded message is played; thus, an infant is incapable of activating playback and another person must be physically present to initiate playback.

Another voice recorder is disclosed in U.S. Patent Publication No. 2004/0010413 A1, wherein the voice recorder, upon entering a playback mode, activates a movable figurine which moves in synchronization with the recorded voice message. However, playback of the voice message is not triggered remotely and requires manual activation by another person.

U.S. Pat. No. 6,692,330 discloses an infant toy having a soft exterior surface which allows playback of pre-recorded sounds. Playback of the sounds may automatically stop after a pre-determined period of time. The infant toy does not have remote activation functionality.

U.S. Patent Publication No. 2004/0130449 A1 discloses a baby-soothing device in combination with a remote monitor. The device is capable of automatically playing back pre-recorded audio messages and displaying visual stimuli in response to voice activation from the infant. The device also monitors audio sounds at the baby-side and transmits these sounds to a caretaker unit. However, playback of the audio is not triggered remotely.

Therefore, a need exists for, among other things, a method and remotely activated device, such as a child/infant toy, for playing pre-recorded voice recordings to a listener when the speaker of the recordings (e.g., a mother) is not physically present that overcome the shortcomings of the prior art.

### BRIEF DESCRIPTION OF THE DRAWINGS

FIG. 1 is a block diagram of an exemplary infant entertainment system in accordance with one embodiment of the present invention.

FIG. 2 is a front elevational view of a remotely activatable audio player inscribed with an advertiser's or sponsor's logo, in accordance with an exemplary embodiment of the present invention.

FIG. 3 is a rear elevational view of the remotely activatable audio player of FIG. 2.

FIG. 4 is an electrical block diagram of a remotely activatable audio player in accordance with one embodiment of the present invention.

FIG. 5 is an electrical block diagram of a wireless remote control for remotely activating an audio player in accordance with another embodiment of the present invention.

FIG. 6 is a logic flow diagram illustrating steps executed by a remotely activatable audio player to playback a pre-recorded parental voice recording and associated trade message to an infant and surrounding persons in accordance with an exemplary embodiment of the present invention.

FIGS. 7 and 8 are exemplary front elevational views of remotely activatable audio players shaped to resemble associated consumer products in accordance with alternative embodiments of the present invention.

### DETAILED DESCRIPTION OF EXEMPLARY EMBODIMENT(S)

Before describing in detail exemplary embodiments that are in accordance with the present invention, it should be observed that the embodiments reside primarily in combinations of apparatus components and processing steps related to implementing a method and associated apparatus for remotely triggering playback of audio personalized for association with a listener (e.g., intended to be calming and/or instructional to a child or infant) through, for example, a toy device having a further optional association with an independent business. Accordingly, the apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms, such as “first” and “second,” “top” and “bottom,” and the like, may be used solely to distinguish one entity or element from another entity or element without necessarily requiring or implying any physical or logical relationship or order between such entities or elements. The terms “comprises,” “comprising,” or any other variation thereof are intended to cover a non-exclusive inclusion, such that a process, method, article, or apparatus that comprises a list of elements does not include only those elements, but may include other elements not expressly listed or inherent to such process, method, article, or apparatus. The term “plurality of” as used in connection with any object or action means two or more of such object or action. A claim element proceeded by the article “a” or “an” does not, without more constraints, preclude the existence of additional identical elements in the process, method, article, or apparatus that includes the element.

Generally, the present invention encompasses a method and apparatus for remote playback of a recorded audio message personalized for association with a listener (e.g., audio intended to be comforting and/or instructional to a child). In one embodiment, a remotely activatable audio player stores a first audio message personalized for association with a listener (e.g., intended to be a calming and/or instructional influence on the child) and a second audio message not personalized for association with a listener (e.g., not necessarily intended to be a calming or instructional influence on the child). For example, the first message may be a lullaby either in instrumental form or sung by the child's parent and the second message may be an advertisement or other message associated with a sponsoring business. Some time after storage of the two messages, the audio player receives a control command from a remote device and, responsive thereto, plays the two stored messages in a predetermined arrangement and/or order (e.g., the personalized message first and then the other message or vice versa, or only the personalized message where the non-personalized message is played only periodically or at intermittent intervals) such that the messages may be heard by the listener and any other persons in proximity of the audio player. In an alternative embodiment, the audio player may store the message intended to be personalized for an expected listener (e.g., a child) but exclude the non-personalized message.

By configuring and remotely operating an audio player in this manner, the present invention enables a caretaker to temporarily attend to a child's needs by proxy through the audio player during times when the caretaker cannot physically attend to the child's needs (e.g., when the caretaker is driving a car). Additionally, the present invention allows advertisers to brand their messages and products to children and their parents in a setting that is generally soothing to both and, therefore, favorable to the sponsoring businesses.

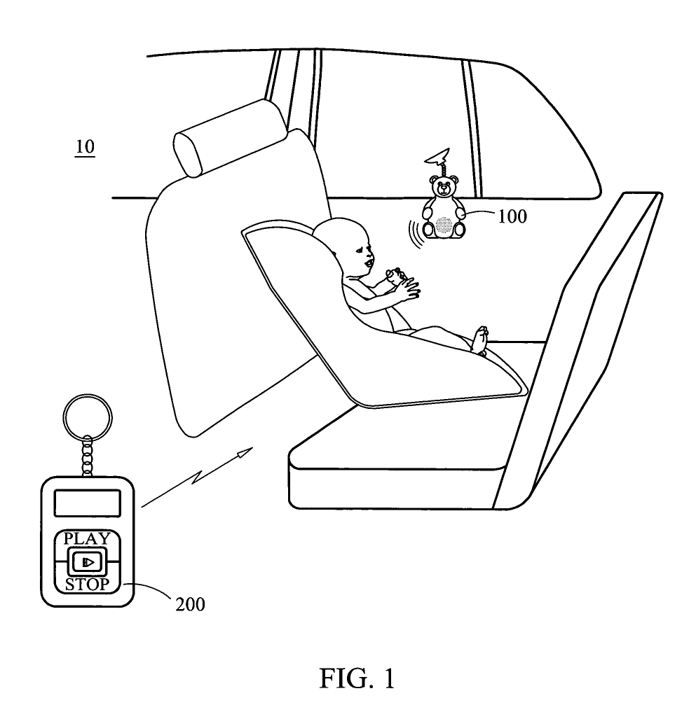

The present invention can be more readily understood with reference to FIGS. 1-7, in which like reference numerals designate like items. FIG. 1 illustrates a block diagram of an exemplary infant entertainment system 10 according to one embodiment of the present invention. The system includes a remotely activatable audio player 100 and a wireless remote control 200 (e.g., a key fob). The audio player 100 is preferably located proximate to an infant or child. The child's caretaker may activate the audio player 100 to begin, pause, resume, or stop playing a pre-recorded message by simply pressing a corresponding button on the wireless remote control 200.

The remote playback feature allows the caretaker to, at least temporarily, comfort the child without physically intervening or interacting with the child. For example, when in a car, an infant is usually riding in a rear-facing car seat that is located in the back seat. When only one adult is present, that adult is necessarily driving the car. If the infant starts to cry, the adult is unable to immediately turn his/her attention to the infant. A crying infant distracts the driver from focusing attention on the road and presents a dangerous situation, not only for the immediate occupants of the car, but also for other vehicles and pedestrians near the car. Playing a pre-recorded message of the parent's voice, particularly when the message is of a parent singing a lullaby, may be a comforting influence on the child and may quiet the child long enough to allow the driver to safely arrive at a location where he/she is able to adequately attend to the child.

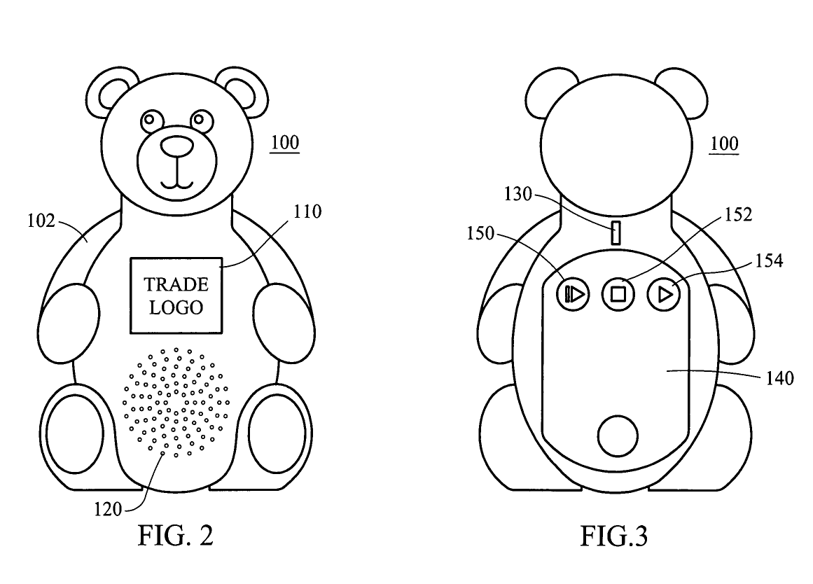

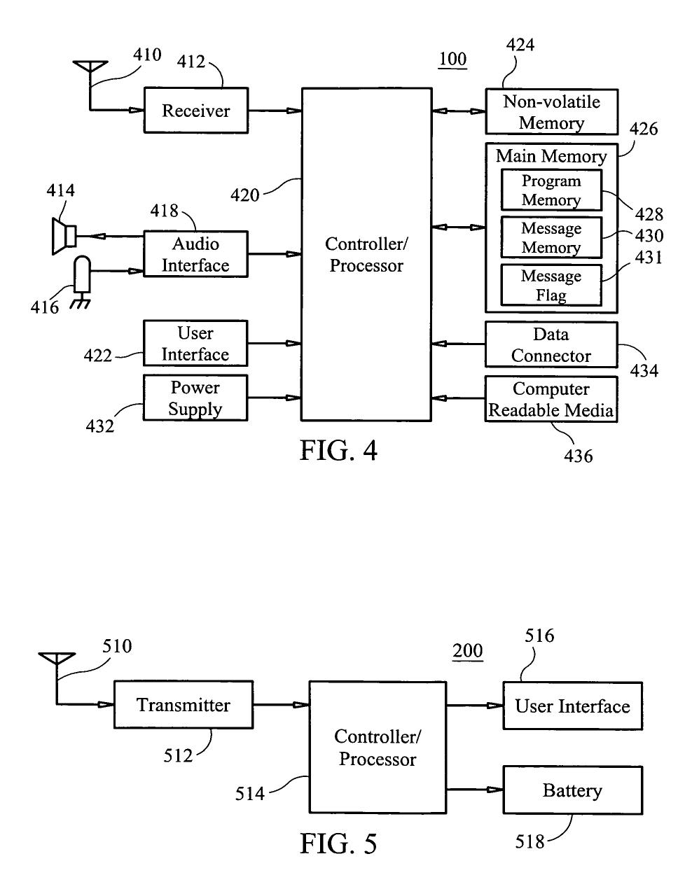

FIGS. 2 and 3 depict front and rear elevational views of an exemplary audio player 100. An outer casing 102 of the audio player 100 may be shaped to resemble any object that would be visually pleasing or stimulating to a child or infant. For example, and not for any purposes of limitation, the audio player 100 depicted in FIGS. 2 and 3 is shaped to resemble a teddy bear. The outer casing 102 defines a plurality of apertures 120 located above or adjacent to an internal speaker (as shown in FIG. 4) or audio transducer, allowing the sounds from the speaker to be heard external to the audio player 100. Similarly, the outer casing 102 further defines at least one aperture 130 located above an internal microphone (also shown in FIG. 4) allowing sounds originating external to the audio player 100 to be captured and recorded.

The audio player 100 may also include a representation 110 of a trademark, logo, mascot, character, or other symbol commonly associated with or used to identify other independent consumer goods or their manufacturers, retailers, sponsors, or advertisers. In this manner, any manufacturer of goods or other business may link the audio player 100 to its name brand. Thus, independent businesses are provided a means to establish brand recognition to persons near the infant, or even to the actual infant.

Optional playback controls 150-154 are located directly on the audio player 100 to enable playback of pre-recorded messages without remote activation. For example, a pause button 150, a stop button 152, and a play button 154 allow the caretaker or the child to control the operation of the audio player 100 directly.

A removable battery cover 140 allows easy access to the batteries for replacement when necessary. Additionally, the battery cover 140 may hide or prevent inadvertent access to other connections or controls, such as a USB interface, a removable media reader (e.g., a smart card reader, or a memory stick reader), an AC/DC power supply connector, and/or a record button.

The audio player 100 may further include a removable attachment mechanism 102 (e.g. a suction cup, a strap, a clip, a clamp, a clasp, a tie, or any other device suitable for retaining the voice player in a stable position) to prevent the child from dropping, throwing, or otherwise moving the audio player 100.

Referring now to FIG. 4, an electrical block diagram of an exemplary audio player 100 is shown in more detail according to one embodiment of the present invention. One of ordinary skill in the art will readily recognize and understand that the structure and content of the audio player 100 illustrated in FIG. 4 may vary depending on the specific implementation. In one embodiment, the audio player 100 includes a controller/processor 420, which controls the operation of the audio player 100 according to computer instructions stored in program memory 428. The audio player 100 also includes a non-volatile memory 424 and a main memory 426. In one embodiment, the main memory 426 includes the program memory 428 and a message memory 430. The message memory 430 may contain one or more audio message files that are inaccessible, thus inerasable, by the end-user. The audio message files stored in the message memory 430 may contain information, advertising, slogans, jingles, or other songs relating to a business associated with or independent from the audio player 100. Thus, the audio messages stored in the message memory 430 are not necessarily intended to be or have a calming, comforting or instructional influence on a child.

The controller/processor 420 also operates an audio interface 418 that provides audio signals to a speaker 414 for playback, and receives audio signals from a microphone 416 for recording. When the audio player 100 is in a “record” mode, the controller/processor 420 activates the audio interface 418, which, in turn, enables the microphone 416. An analog-to-digital converter within the audio interface 418 digitizes audio signals picked up by the microphone 416 and the digitized audio is stored in non-volatile memory 424 as an audio message. Audio message files recorded by the end-user may be erased on command. Additionally, or alternatively, audio message files recorded by the end-user may be stored in or on a removable storage media 436 (e.g., a smart card, a memory stick, a USB flash drive, or any other portable data storage device), which also functions under the command of the controller/processor 420. Remotely stored audio message files, such as lullabies or other songs or voice messages, may further be transferred to non-volatile memory 424 through an optional data connector 434 (e.g., a USB port, a serial port, or a fire-wire port) connected to an external audio storage device (e.g., a computer, an external hard drive, a portable audio player, a personal data assistant (PDA), etc.).

During “playback” mode, the controller/processor 420 retrieves audio messages stored in non-volatile memory 424, the message memory 430, and/or the computer readable media 436, and routes the messages to the audio interface 418. A digital-to-analog converter in the audio interface 418 translates the audio messages back to audio signals, which are then played via the speaker 414.

The audio player 100 receives command signals from a wireless key fob 200 or other remote controller in a well-known manner. For example, the controller/processor 420 operates the RF receiver 412, which couples an RF signal from an antenna 410 to the receiver 412 in a well-known manner. The receiver 412 receives, converts, and demodulates the RF signal, providing a control command to the controller/processor 420. Control commands may include: play, pause, resume, stop and record. Additionally, or alternatively, the audio player 400 receives control commands via a user interface 422, such as in response to a user pressing one or more corresponding buttons (e.g., playback controls 150-154). Although the exemplary block diagram of FIG. 4 depicts the audio player 100 as receiving control commands via an RF receiver 412, one of ordinary skill in the art will recognize that other forms of wireless or wired communication receivers or modems (e.g., infrared, Bluetooth, USB, controller area network (CAN) and/or local interconnect network (LIN) bus) may function equally as well.

A power supply 432 provides the necessary energy to operate the audio player 100. The power supply 432 preferably operates using either replaceable or rechargeable batteries to allow the audio player 100 free mobility. However, an optional AC/DC power input jack (not shown) may also be used to supply necessary power. The audio player 100 depicted in block diagram form in FIG. 4 may be used to implement an audio player in any desired housing or casing, such as the casing 102 depicted in FIGS. 1 and 2.

An electrical block diagram of an exemplary wireless remote control 200 is shown in more detail in FIG. 5. Such remote control 200 may be embodied in a key fob as depicted in FIG. 1 or in any other desired housing configuration. In one embodiment of the remote control 200, a controller/processor 514 receives inputs from a user interface 516, which may include a variety of push buttons. A user presses the buttons to enter inputs to the remote control 200. Each button, or pattern of pressed buttons, corresponds to a specific control command. After the controller/processor 514 receives an input from the user interface 516, the controller/processor 514 causes a transmitter 512 to transmit a corresponding control command to the audio player 100 via a transmit antenna 510 using methods well understood by those skilled in the art. The wireless remote control 200 is preferably powered by a small cell battery 518.

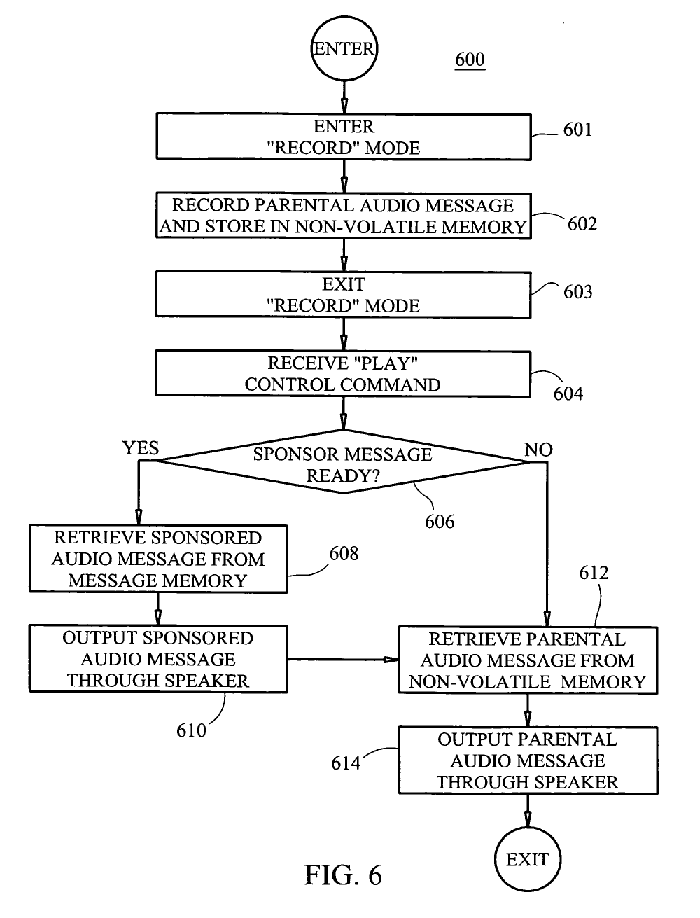

FIG. 6 illustrates an exemplary operational flow diagram 600 for a method of remotely playing audio recordings of a parent's voice or other soothing audio to a child, in accordance with one embodiment of the present invention. The method of FIG. 6 operates in conjunction with a remotely activatable audio player. First, the audio player enters (601) a “record” mode. Generally, the audio player enters the “record” mode responsive to user (e.g., parent) input, such as when the user has pressed a dedicated record button; however, other means of entering “record” mode may be used (e.g., the user enters a certain sequence of button presses; a specific button is engaged for an extended period of time, such as, for example, five seconds; the audio player defaults to “record” mode upon having power interrupted and reapplied, etc.).

The audio player records (602) a personalized audio message, for example, containing a voice of a child's parent or other sounds, voices or music intended to have or be a calming, soothing, comforting, or instructional influence on the child, by capturing audio signals via a microphone, digitizing the captured audio signals with an analog-to-digital converter, and storing the digitized information in a memory. Alternatively, an audio message may be transferred to the memory from an external storage device using a data connector 434. When the audio message has been stored in the memory, the audio player exits (603) “record” mode.

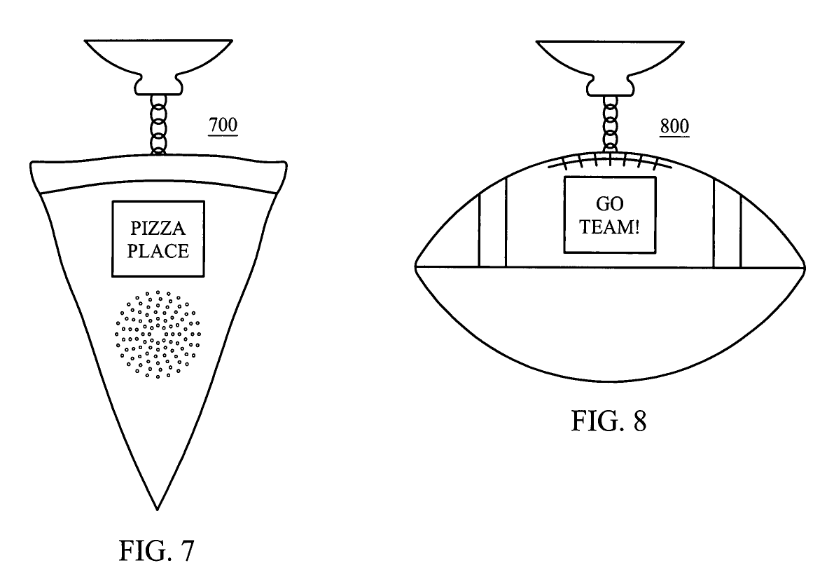

Next, the audio player receives (604) a “play” control command either from a wireless remote control, or in response to a user pressing a “play” button located on the audio player. Responsive to receiving the “play” command, the audio player checks (606) its memory to determine if a sponsored or other non-personalized audio message is stored. The sponsored audio message is an audio file that is pre-stored into the audio player's memory during manufacturing and is not erasable by or accessible to the end-user. The sponsored audio message may contain information relating to an independent consumer product or service associated or identified with a trade name, logo, symbol, or other identification information of a sponsor, advertiser, manufacturer or retailer, which may have its logo, symbol, trade name, or other identifier prominently displayed on the audio player. Alternatively, or additionally, the audio player may be shaped to resemble a consumer product, logo, symbol, mascot, or character associated with the sponsor, advertiser, manufacturer or retailer, or with information contained in the sponsored audio message. For example, referring to FIG. 7, if the sponsor were a pizza restaurant, the audio player 700 may be shaped to resemble a slice of pizza and the sponsored audio message may be the restaurant's jingle. FIG. 8 illustrates an exemplary audio player 800 wherein the sponsor is a football team and the sponsored audio message could be the team fight song or just a short message saying, “Go team!” By playing the sponsored audio message and associating the audio player with a sponsor, persons near the child, as well as the actual child, are exposed to positive qualities that the sponsor wishes to portray.

The sponsored audio message and the calming/instructional audio message are preferably played according to a predetermined arrangement. For example, the sponsored audio message may be played every time the audio player enters the “play” mode or may be played less frequently. For instance, the sponsored audio message may be played only once for every time the parental audio message is played a specified number of times (e.g., the sponsored audio message plays after every tenth playing of the parental voice message). Alternatively, the sponsored audio message may only be played when the audio player initially receives a “play” control code after having not received a “play” control code for a predetermined amount of time (e.g., the sponsored audio message may only play when the audio player has not played any messages during the prior fifteen minutes). Because the sponsored audio message does not necessarily need to be played every time the audio player receives a “play” control command, the audio player (e.g., through its controller/processor) may check other indicators, such as, referring to FIG. 4, a message flag 431, to determine if the sponsored audio message is ready to be played.

If the sponsored audio message is ready for playing, the audio player retrieves (608) the sponsored audio message from its memory and internally routes the information to an audio interface. The audio interface converts the digital information contained in the sponsored audio message to an audio signal and outputs (610) the audio signal through the audio player's internal speaker. Then, as with the sponsored audio message, the audio player retrieves (612) the parental or other soothing, calming, or instructional audio message from memory, routes the information contained in the parental audio message to the audio interface which, in turn, converts the digital information to an audio signal and outputs (614) the audio signal through the speaker. Alternatively, the parental or other soothing, calming, or instructional audio message may be retrieved from memory and played first, followed by the sponsored audio message, or may be played without the sponsored audio message as noted above.

If the sponsored audio message is not ready, the audio player skips directly to step 612 and proceeds to play the parental voice message. Instructions for executing some or all of the logic steps discussed above with respect to FIG. 6 are optionally stored as computer or controller readable software or code in a memory of the audio player (e.g., in program memory 428) and executed by a controller or processor (e.g., controller/processor 420) of the audio player.

In the foregoing specification, the present invention has been described with reference to specific embodiments. Specifically, a method and apparatus for playing back a personalized message to a child, in conjunction with a sponsored message have been discussed in detail. However, one of ordinary skill in the art will appreciate that various modifications and changes may be made without departing from the spirit and scope of the present invention as set forth in the appended claims. For example, the targeted audience for the method and remotely activatable audio player described above is not intended to be limited to a child. Any person in the audible vicinity of the audio player may receive personalized and corresponding sponsored audio messages. Accordingly, the specification and drawings are to be regarded in an illustrative rather than a restrictive sense, and all such modifications are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions to become more pronounced are not to be construed as a critical, required, or essential feature or element of any or all the claims. The invention is defined solely by the appended claims including any amendments made during the pendency of this application and all equivalents of those claims as issued.

What is claimed is:

1. A method for providing recorded audio messages to at least one listener, the method comprising:
storing a first recorded audio message that has been personalized for association with an intended listener;
storing a second recorded audio message that has not been personalized for association with the intended listener;
receiving a control command from a remote control device; and
responsive to receiving the control command, playing the first recorded audio message and the second recorded audio message according to a predetermined arrangement.

2. The method of claim 1, wherein the step of receiving a control command comprises:
receiving a control command from a wireless remote control device.

3. The method of claim 1, wherein the second recorded audio message includes information associated with a consumer product or service offered by a sponsoring business.

4. The method of claim 3, wherein the second recorded audio message includes at least one of a slogan, a song, a jingle, and audio information relating to the sponsoring business.

5. The method of claim 1, wherein the intended listener is a child, wherein the first recorded audio message is intended to have at least one of a calming and instructional influence on the child, and wherein the second recorded audio message is not intended to have at least one of a calming and instructional influence on the child.

6. The method of claim 1, wherein the step of playing the first recorded audio message and the second recorded audio message according to a predetermined arrangement comprises:
prior to playing the first recorded audio message, determining whether the second recorded audio message is ready to be played; and
if the second recorded audio message is not ready to be played, playing only the first recorded audio message.

7. The method of claim 6, wherein the step of determining whether the second recorded audio message is ready to be played comprises:
determining that the control command has not been received for a predetermined amount of time.

8. The method of claim 6, wherein the step of determining whether the second recorded audio message is ready to be played comprises:
determining that only the first recorded audio message has been played in response to previously receiving a predetermined number of consecutive control commands.

9. The method of claim 1, wherein the step of playing the first recorded audio message and the second recorded audio message according to a predetermined arrangement comprises:
playing the first recorded audio message and the second recorded audio message in a predetermined order.

10. A remotely activatable audio player comprising:
a first memory operable to store a first recorded audio message that has been personalized for association with an intended listener;
a second memory operable to store a second recorded audio message that has not been personalized for association with the intended listener;
a controller, communicatively coupled to the first memory and the second memory, operable to retrieve the first recorded audio message and the second recorded audio message according to a predetermined arrangement responsive to receiving control commands from a remote control device to produce at least one retrieved audio message;
an audio output device coupled to the controller and operable to output audio signals corresponding to the at least one retrieved audio message responsive to signaling from the controller; and
a housing enclosing the controller, the first memory, the second memory, and the audio output device.

11. The audio player of claim 10, further comprising:
a receiver, coupled to the controller, for receiving wireless control commands from a wireless remote control device.

12. The audio player of claim 10, wherein the second recorded audio message is associated with a consumer product or service offered by a sponsoring business.

13. The audio player of claim 12, wherein the housing includes a representation of at least one of a trade name, a trademark, a logo, a symbol, a mascot, a character, and a product associated with the sponsoring business.

14. The audio player of claim 12, wherein the housing is shaped to resemble at least one of a trade name, a trademark, a logo, a symbol, a mascot, a consumer product, and a character associated with the sponsoring business.

15. The audio player of claim 12, wherein the second recorded audio message includes at least one of a slogan, a song, a jingle, and advertising relating to the sponsoring business.

16. The audio player of claim 10, wherein the intended listener is a child, wherein the first recorded audio message is intended to have at least one of a calming and instructional influence on the child, and wherein the second recorded audio message is not intended to have at least one of a calming and instructional influence on the child.

17. The audio player of claim 10, further comprising:
at least one button, communicatively coupled to the controller, for entering local control commands, wherein the controller is further responsive to the local control commands to retrieve the first recorded audio message and the second recorded audio message according to the predetermined arrangement.

18. The audio player of claim 10, wherein the predetermined arrangement is a predetermined order and the controller is operable to signal the audio output device to output the first recorded audio message and the second recorded audio message in the predetermined order.

19. A system for playing recorded audio messages, the system comprising:
a remote control device operable to transmit control commands; and
a remotely activatable audio player that includes:
a first memory operable to store a first recorded audio message that has been personalized for association with an intended listener,
a second memory operable to store a second recorded audio message that has not been personalized for association with the intended listener,
a controller, communicatively coupled to the first memory and the second memory, operable to retrieve the first recorded audio message and the second recorded audio message according to a predetermined arrangement responsive to receiving control commands from the remote control device to produce at least one retrieved audio message,
an audio output device coupled to the controller and operable to output audio signals corresponding to the at least one retrieved audio message responsive to signaling from the controller, and
a housing enclosing the controller, the first memory, the second memory, and the audio output device.

20. The system of claim 19, wherein the predetermined arrangement is a predetermined order and the controller is operable to signal the audio output device to output the first recorded audio message and the second recorded audio message in the predetermined order
